(19) United States
(12) Patent Application Publication
(10) Pub. No.: US 2026/0300807 A1
(43) Pub. Date: Oct. 1, 2026

(54) SELF-LEARNING SYSTEMS AND METHODS USING MOVING EUCLIDEAN DISTANCE MACHINE-LEARNING MODELS FOR ANOMALY AND TREND DETECTION IN TIMESERIES DATA

(71) Applicant: Savant Solutions LLC, Livonia, MI (US)

(72) Inventor: Ashutosh Srivastava, Bangalore (IN)

(73) Assignee: Savant Solutions LLC, Livonia, MI (US)

(21) Appl. No.: 19/092,360

(22) Filed: Mar. 27, 2025

(51) Int. Cl. G06N 20/00; G06F 18/10; G06F 18/22

(52) U.S. Cl. CPC G06N 20/00; G06F 18/10; G06F 18/22

(57) ABSTRACT

Presented are self-learning systems for anomaly detection in timeseries datasets utilizing Euclidean geometry modeling and methods of operating such systems. A method of analyzing datasets to detect anomalies includes a system controller receiving a timeseries dataset containing a sequence of data values recorded within a select time period, and determining a window length defining a number of the sequential data values assigned to each data window. The controller assigns a respective subsequence of the data values to each data window in a series of data windows, and generates a distance value matrix with matrix cells that contain Euclidean distances between respective pairs of the data windows. The controller generates a shortest distance (SD) matrix containing SD values that each defines a shortest distance between each data window and every other data window. The SD array is analyzed to determine if any SD value is irregular and thereby indicates an anomaly.

### INTRODUCTION

The present disclosure relates generally to systems and methods for evaluating collected data. More specifically, aspects of this disclosure relate to self-learning systems for analyzing real-time timeseries data streams to identify data trends and anomalies.

Data may be collected in a variety of different formats, from cross-sectional data and spatial data to categorical data and timeseries data. Timeseries data may be typified by a sequence of data points that is collected and recorded at successive points over consistent intervals of time in a select time period. As a point of comparison, cross-sectional data typically captures data for multiple variables at a single point in time, providing a “snapshot” of various attributes at a specific moment. Where cross-sectional data may evaluate and contrast different entities at a single point in time, timeseries data may focus on trends and changes within a single entity over a specific time period. Each data point in a timeseries dataset may be marked with a respective timestamp, and the data points are ordered and evaluated chronologically. Timeseries data is often used for forecasting, anomaly detection, and identifying underlying patterns or temporal trends across innumerable industries, including stock prices, website traffic, weather data, etc.

There are three major challenges associated with collecting and evaluating real-time, time-sensitive data: (1) unspecified data traits, (2) disjointed or broken datasets, and (3) unknown data constraints. For example, discerning particular characteristics of a subject dataset, such as whether its analogous or discrete, whether there are trends or seasonality patterns, etc., oftentimes requires a separate study of previously accumulated historical data. Additionally, many timeseries datasets are not continuous or contain gaps. For example, a batch process may generate one set of data with associated characteristics for one batch and another set of data with different characteristics for another batch, making historical study of the data problematic. Many timeseries data streams, such as for financial transactions, are not continuous; filling interludes in the data stream, e.g., through interpolation, is labor-intensive, time consuming, and prone to error. Some timeseries data, such as sensor-based data, may have innate limitations; in many cases, however, these thresholds are not known and must be derived through historical reference.

### SUMMARY

Presented below are self-learning systems with attendant control logic for anomaly detection in timeseries data utilizing Euclidean geometry modeling, methods for operating such systems, and memory-stored, computer-readable code for provisioning such system control logic. By way of non-limiting example, an intelligent computational system employs a trained and supervised machine-learning (SML) module that utilizes a moving Euclidean distance model to flatten a timeseries dataset and detect anomalies and trends in real-time timeseries data streams. Rather than using conventional anomaly-scoring, threshold-comparison, or metric-weighting techniques to detect trends and anomalies, the SML-driven, self-learning system focuses on a predetermined length of the timeseries data (e.g., 1 day, 5 days, 5 years, etc.) to train and normalize the data irrespective of whether it is continuous, analog, discrete, or batch based. The system does so using a moving Euclidian distance model, but instead of applying Euclid's theorem to only two points in Euclidean space—traditional Euclidean mathematics—the system applies the theorem between corresponding points within juxtaposed time windows of a timeseries dataset and applies it to all windows of the entire dataset. Doing so generates a flattened timeseries even if the data is broken or noisy. If a line graph of the result is drawn, segments of the line that are not flat may be designated as anomalous (e.g., a marked deviation from algorithmically-determined behavior).

Attendant benefits for at least some of the disclosed concepts may include accelerated identification of trends and detection of anomalies in timeseries data streams with limited or no historical data and agnostic to any dataset-specific characteristics and limitations. In addition, disclosed moving Euclidean distance SML models may be implemented in a variety of different applications, including for Internet of Things (IoT) devices, financial transactions, anti-money laundering, risk reporting, autonomous vehicles (AV), and instances in which real-time timeseries data often crosses thresholds. Other attendant advantages may include drastic reductions in computational load, real-time anomaly detection in massive timeseries datasets, and elimination of time-consuming parameter tuning. Compared to many traditional anomaly detection techniques, which solve a specific problem (e.g., similarity search or curve smoothening), disclosed systems and methods may encompass a complete life cycle of anomaly detection, which is repeatable, fast, and is adaptable to modern computation hardware and networked computing architectures. Further benefits may include simplified product backtesting and repeatability as the algorithms can be traced back on a sample of data, which helps to demonstrate the authenticity and durability of the process.

Aspects of this disclosure are directed to AI-driven, self-learning systems and control processes for detecting trends and anomalies in timeseries data utilizing Euclidean geometry modeling along with forecasting modeling. In an example, a method is presented for analyzing datasets to detect anomalies in data values contained in the datasets. This representative method includes, in any order and in any combination with any of the above and below disclosed options and features: receiving, e.g., via a system controller from a data source, a timeseries dataset containing a sequence of data values recorded within a select time period; determining, e.g., via the system controller for the timeseries dataset, a window length defining a number of sequential values in the sequence of data values assigned to each of a series of data windows; enumerating, e.g., via the system controller from the timeseries dataset, the series of data windows, including assigning a respective subsequence of values from the sequence of data values to each data window in the series of data windows; generating, e.g., via the system controller based on a total number of the data windows, a distance value matrix containing an array of matrix cells, each cell in the distance value matrix including a Euclidean distance between a respective pair of the data windows; generating, e.g., via the system controller from the distance value matrix, a shortest distance (SD) matrix containing an array of SD values, each of which defines a shortest distance between each of the data windows and every other one of the data windows; and analyzing, e.g., via the system controller, the SD array to determine whether or not one or more of the SD values is irregular relative to the other SD values and thereby indicates an anomaly is present.

Aspects of this disclosure are also directed to memory-stored, computer-readable media (CRM) containing controller-executable instructions for optimizing anomaly detection in timeseries data streams utilizing Euclidean geometry modeling. In an example, a non-transient CRM stores instructions that are executable by one or more processors of a system controller of a self-learning anomaly detection system. These CRM-stored instructions, when executed by the processor(s), cause the system controller to perform operations, including: receiving, from a data source, a timeseries dataset containing a sequence of data values recorded within a select time period; determining, for the timeseries dataset, a window length defining a number of sequential values in the sequence of data values assigned to each of a series of data windows; enumerating, from the timeseries dataset, the series of data windows including assigning a respective subsequence of values from the sequence of data values to each data window in the series of data windows; generating, based on a total number of the data windows, a distance value matrix containing an array of matrix cells, each cell in the array of matrix cells including a Euclidean distance between a respective pair of the data windows; generating, from the distance value matrix, a shortest distance matrix containing an array of shortest distance values, each of the SD values defining a shortest distance between each of the data windows and every other one of the data windows; and analyzing the SD array to determine whether or not one of the SD values is irregular relative to the other SD values and thereby indicates an anomaly.

For any of the herein described systems, methods, and CRM, enumerating the series of data windows may include calculating a total number of windows as W_{T}:

$${W}_{T} = T - {L}_{W} + 1$$

where Lₙ is a total number of data values in the sequence of data values in the timeseries dataset T, and L_{W} is the window length determined for the timeseries dataset T. As a further option, generating the distance value matrix may include determining a matrix size [R_{N}, C_{N}] of the distance value matrix, where R_{N} is a number of matrix rows, C_{N} is a number of matrix columns, and R_{N}=C_{N}=W_{T}. Moreover, analyzing the SD array may include determining whether or not each of the SD values in the SD array is significantly larger than most or all other of the SD values in the SD matrix. In this instance, determining whether or not an SD values is significantly larger than most or all other of the SD values in the SD matrix may include applying a 95^{th} or 99^{th} percentile rule analysis to each of the SD values in the SD matrix.

For any of the herein described systems, methods, and CRM, generating the distance value matrix may include calculating each of the Euclidean distances as D_{E}(A, B):

$${D}_{E} = √ [ {( {a}_{1} - {b}_{1} )}^{2} + {( {a}_{2} - {b}_{2} )}^{2} + … + {( {a}_{m} - {b}_{m} )}^{2} ]$$

where A=[a₁, a₂, . . . , aₘ], A is a first data window in the respective pair of the data windows, a₁, a₂, . . . , aₘ are the 1^{st}, 2^{nd}, . . . and m^{th} data values in the respective subsequence of values assigned to the first data window A, B=[b₁, b₂, . . . , bₘ], B is a second data window in the respective pair of the data windows, and b₁, b₂, . . . , bₘ are the 1^{st}, 2^{nd}, and . . . m^{th} data values in the respective subsequence of values assigned to the second data window B. As a further option, generating the SD matrix may include calculating each of the SD values as SD[i]:

$$S D [ i ] = min ( {D}_{i , j} )$$

where D_{i,j} is an i^{th} cell in the distance value matrix, and where i!=j.

For any of the herein described systems, methods, and CRM, a supervised machine learning (SML) model may be trained to detect anomalies in the timeseries dataset. The training may include receiving a training timeseries dataset containing one or more recorded anomalies, and determining multiple distinct data windows for the actual timeseries dataset. In this instance, training the SML model may further include creating multiple base datasets, each of which may be created by subtracting a respective one of the distinct data windows from the timeseries dataset. As a further option, training the SML model may further include generating a forecasted data series by applying one or more statistical timeseries forecasting models to the base datasets. After generating the forecasted data, a forecasting model may be derived by comparing the forecasted data series with the timeseries dataset.

For any of the herein described systems, methods, and CRM, training the SML model may further include finding the Euclidean distance between respective pairs of data windows in the base datasets and the forecasted data series. Training the SML model may also include: generating a training SD matrix containing an array of training SD values, each of the SD values defining a shortest distance between each of the respective pairs of the data windows in the base datasets and the forecasted data series; and determining if one or more anomalies are present by applying a 95^{th} or 99^{th} percentile rule analysis to determine if each of the training SD values is significantly larger than most or all other of the training SD values in the training SD matrix. As a further option, the data source that generates the timeseries data may include one or more WiFi-enabled sensors or IoT devices, and the timeseries dataset may include a real-time data stream output by each WiFi-enabled sensor/IoT device. In this instance, one or more operating thresholds and/or one or more operating settings of the WiFi-enabled sensor(s)/IoT device(s) may be modulated based on the analysis of the SD array. Disclosed anomaly detection techniques may be implemented to optimize operation of an autonomous vehicle, an automated assembly line, an emergency weather prediction system, a finance analytics system, a communications system, etc.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative AI-driven, self-learning computational system that identifies trends and detects anomalies in timeseries data using Euclidean distance modeling in accord with aspects of the present disclosure.

FIG. 2 is a flowchart illustrating a representative anomaly detection system control protocol utilizing moving Euclidean distance SML models to identify anomalies within real-time timeseries data streams, which may correspond to non-transient, memory-stored instructions that are executable by a resident or remote processor, microcontroller, control module, programmable logic circuit, central controller, or other integrated circuit (IC) device or network of controllers/processors/modules/devices/etc., (collectively “controller” or “system controller”) in accord with aspects of the disclosed concepts.

FIG. 3 is a line graph illustrating a representative “raw” timeseries dataset with which aspects of this disclosure may be practiced.

FIG. 4 is a line graph illustrating a representative “flattened” timeseries dataset generated by applying disclosed moving Euclidean distance SML models to the timeseries dataset of FIG. 3.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “exactly or reasonably close to,” or any logical combination thereof, for example.

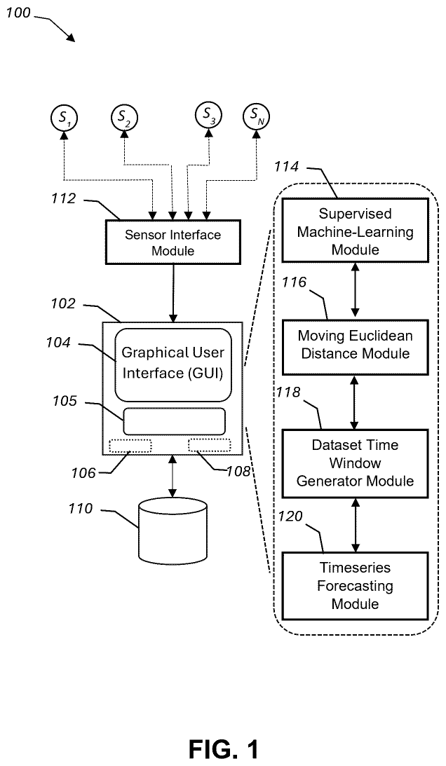

Referring now to the drawings, wherein like reference numbers refer to like features throughout the several views, there is shown in FIG. 1 a representative AI-driven, self-learning computational system 100 for identifying trends and detecting anomalies in timeseries data using Euclidean distance modeling. The illustrated self-learning computational system 100—also referred to herein as “anomaly detection system” or “computer system” for brevity—is merely an exemplary application with which aspects of this disclosure may be practiced. In the same vein, utilization of the present concepts for optimizing the operation of a sensor or an IoT device should also be appreciated as a non-limiting implementation of disclosed concepts. As such, it will be understood that novel aspects of this disclosure may be utilized to optimize operation of innumerable types of devices, may be incorporated into other computer system architectures, and may be scaled and adapted for implementation into any logically relevant industry. Moreover, only select components of the anomaly detection system 100 are shown and will be described in detail herein. Nevertheless, the systems discussed below may include numerous additional and alternative features, and other available peripheral hardware, for carrying out the various methods and functions of this disclosure.

The anomaly detection system 100 of FIG. 1 is presented as a back-office (BO) control center in a distributed computing network architecture that contains a server-class computer work station 102 with an interactive graphical user interface (GUI) 104 through which a user interacts with the system 100. The work station 102 may be generally composed of one or more processors 106, each of which may be embodied as a discrete microprocessor, an application specific integrated circuit (ASIC), a dedicated control module, a central processing unit (CPU), and combinations thereof. The work station 102 may also be equipped with an assortment of different user input controls 105 (e.g., touchpads, touchscreens, key pads, voice-input hardware, etc.) by which a user enters inputs, selections, and commands. The processor(s) 106 may be operatively coupled to a real-time clock (RTC) and one or more electronic memory devices 108, each of which may take on the form of a CD-ROM, magnetic disk, IC device, solid-state drive (SSD) memory, hard-disk drive (HDD) memory, phase-change memory (PCM), flash memory, semiconductor memory (e.g., various types of RAM or ROM), etc. A System Database Storage device 110, which may be in the nature of a resident server-class database or a remote cloud-based storage service, may aggregate, filter, collate, map and store some or all collected data for future reference and analysis. Unlike conventional desktop and laptop computers, which offer limited storage, processing, and data management capabilities, server-class computers have more powerful processors, larger memory capacities, and advanced data integration features to enable high uptime and continuous operation with protective redundancies and to handle heavy workloads.

System Data Storage device 110 may store real-time timeseries data streams captured through a sensor interface module 112 from a networked array of sensing devices S₁, S₂, S₃, . . . S_{N}. Each sensing device S₁, S₂, S₃, . . . S_{N} may be in the nature of a pressure sensor, a temperature sensor, a dynamics sensor, an optical sensor, a range sensor, a proximity sensor, a voltage/current sensor, etc. Alternatively, each device S₁, S₂, S₃, . . . S_{N} of FIG. 1 may be embodies as a WiFi-enabled Internet of Things (IoT) device, non-limiting examples of which may include smart home IoT devices, industrial IoT devices, infrastructure IoT devices, etc. Collection, processing, and evaluation of such timeseries data may facilitate optimization operation of the aforementioned sensors/IoT devices within a manufacturing facility, an autonomous vehicle, an advanced processing plant, a server farm, a supercomputer or cloud computing system, etc.

Work station 102 may contain or, if desired, may communicate over a high-integrity serial bus system of a controller area network (CAN) with a network of interoperable control modules for performing trend identification and anomaly detection in timeseries datasets. In FIG. 1, for example, the work station 102 contains or communicates with a supervised machine-learning (SML) module 114, a moving Euclidean distance module 116, a dataset time window generator module 118, and a timeseries forecasting module 120. As will be explained in further detail below, the SML module 114 may be trained to generate forecasting models that are used to create forecasted datasets that facilitate timeseries analysis and any concomitant anomaly detection. Moving Euclidean distance module 116 coordinates with the SML module 114 to provide pairwise Euclidean distance calculations for building distance matrices used in the anomaly detection process. To build these matrices, the moving Euclidean distance module 116 coordinates with the dataset time window generator module 118 to select a single or multiple window lengths for each subject timeseries dataset. The timeseries forecasting module 120 utilizes the forecasting model output by the SML module 114 to create forecasted datasets, e.g., using a variety of different statistical models (ARIMA, Prophet, LSTM-based recurrent neural network (RNN), etc.).

Anomaly detection system 100 may provide fast detection of anomalies and observations in timeseries datasets agnostic of the dataset's characteristics and irrespective of whether or not there is limited or no historical data available for a given set. System 100 may focus on a predetermined length of the timeseries data (e.g., 1 day, 5 days, 1 month, 5 months, etc.) and may normalize the data regardless of whether it is continuous, analog, discrete, or batch based. The data may be normalized by applying a Euclidian distance principle to respective pairs of data values (“points”) within data windows (“frames”) of the dataset and applied to every point of every frame within the entire dataset. Doing so may generate a “flattened” timeseries even if the raw timeseries dataset is very noisy. If a line graph of the resultant dataset is created, each section of the line that is not “flat” may be considered to be anomalous.

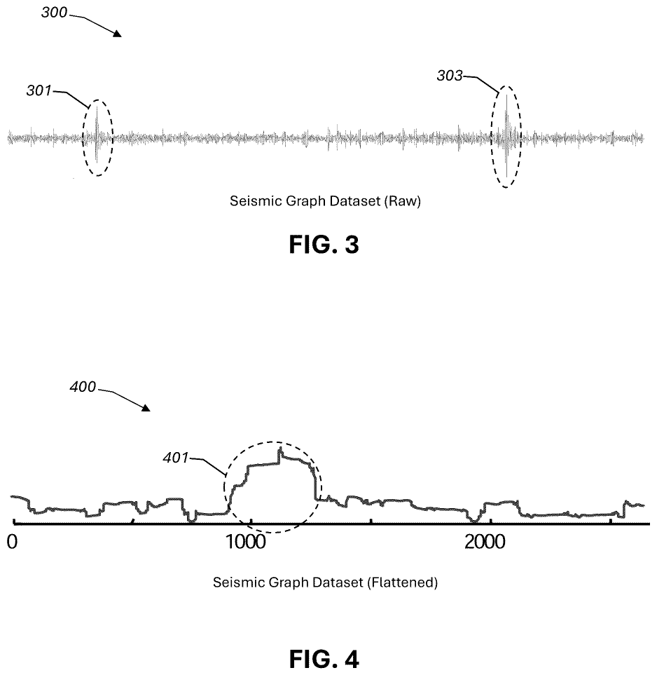

FIG. 3 illustrates a representative “raw” timeseries dataset 300, which is presented as a line graph of a select time period (e.g., 2700 seconds) of a sample of seismic data taken from an open dataset. As is evident from this line graph, the dataset 300 it very dense, very noisy, and contains at least two seismic anomalies 301 and 303. A general study of this dataset using a conventional class of algorithms would typically require deriving trends and seasonality while also identifying any gaps in the data, which may or may not be present. However, using the techniques described herein, including calculating Euclidean distances between metric values in paired data frames, a smoothed and flattened line graph may be generated, an example of which is designated 400 in FIG. 4. As can be seen, the dense raw data is flattened whenever the dataset's values are similar or close; conversely, the resultant graph line shows fluctuations where the dataset's values are not similar/close. A marked aberration in FIG. 4 aligns with an anomaly 401. As seen in FIG. 4, the aberration peak is not instantaneous but rather is rising, which may imply that the anomaly had rising characteristics before the event occurred. This significant breakthrough means the algorithm can be used to detect the advent of an anomaly as well as the anomaly itself. In other words, the system 100 not only identifies an anomaly but may also generate alerts if it senses an onset of an anomaly.

When the trained SML module 114 implements the moving Euclidean distance model 116 to process a timeseries dataset, the system 100 may systematically and repeatedly execute the following operations:
a) apply the Euclidean distance algorithm to flatten the given timeseries data;
b) search for suggestive rises and falls of a peak in the flattened dataset and accurately identify the time at the onset of the peak;
c) for real-time streaming data, apply a statistical forecasting model (e.g., ARIMA and SARIMA) to the flattened dataset and compare against the real-time data; and
d) if the compared data matches, search for rises and falls of peaks in the forecasted data to predict future anomalies.
   During proof of concept and prototyping, disclosed algorithms were applied to several open datasets and the algorithms continually generate consistent results when applied to the same or similar datasets. Additionally, the algorithms do not require complex hyperparameter tuning, and allow large timeseries datasets to be split into smaller subsets such that the algorithm can be applied to the subsets in parallel space.

Disclosed self-learning anomaly detection systems and methods may help to improve (i.e., simplify and expedite) anomaly detection within timeseries datasets, which in turns improves the functioning of the computer system by reducing computational time and burden. Disclosed systems and methods may also offer drastic improvements in accuracy and consistency over traditional methods of detecting anomalies. In addition to increasing processing speed and efficiency, disclosed self-learning anomaly detection systems and methods may also help to produce fewer errors (minimize false-positive detection) and decrease system storage capacity requirements. Other improvements over conventional anomaly detection techniques can be found in that disclosed techniques may be scaled and adapted to numerous industries, offer improved flexibility by being agnostic to dataset-specific characteristics and usable irrespective of the presence of historical data.

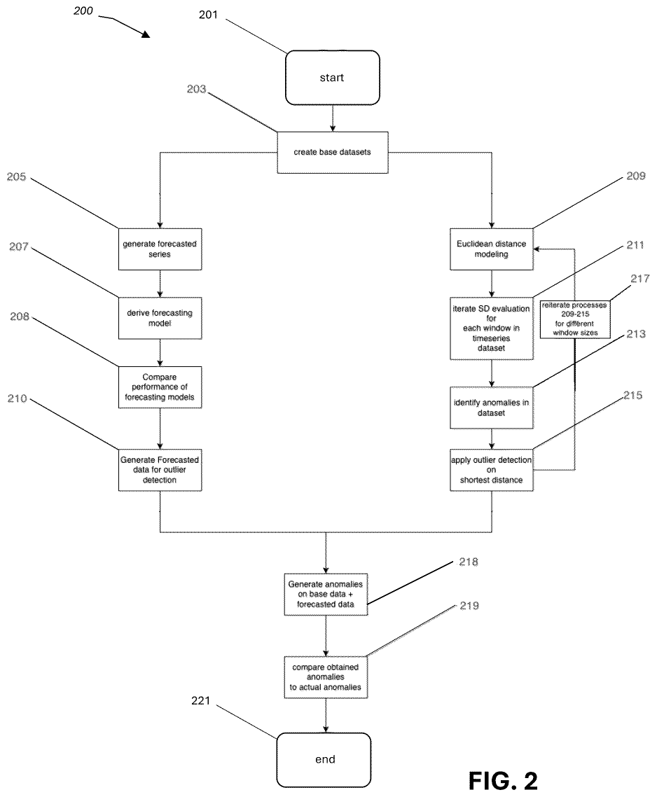

With reference next to the flowchart of FIG. 2, an improved method or control protocol for trend analysis and anomaly detection within a timeseries dataset utilizing moving Euclidean distance models is generally described at 200 in accordance with aspects of the present disclosure. Some or all of the operations illustrated in FIG. 2 and described in further detail below may be representative of an algorithm that corresponds to non-transitory, processor-executable instructions that may be stored, for example, in main or auxiliary or remote memory (e.g., resident memory device 108 and/or System Database Storage device 110 of FIG. 1). These instructions may be executed, for example, by a microprocessor, central controller, dedicated control module, programmable logic circuit, or other module or device or network of controllers/modules/devices (e.g., processor(s) 106 and/or control modules 114, 116, 118, 120 of FIG. 1) to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with instructions to initialize operation of a data monitoring, collection, and analysis system, such as anomaly detection system 100 of FIG. 1. For instance, server-class computer workstation 102 may collect, retrieve, or otherwise receive a timeseries dataset or a select portion of a timeseries dataset from resident memory device 108, System Database Storage device 110, and/or one or more of the sensing devices S₁, S₂, S₃, . . . S_{N}. A data analyst or other validated user, through interactive GUI 104 generated by the workstation 102, may select for analysis one or more portions of one or more data tables that may be stored in one or more datastores. By way of non-limiting example, a vehicle ADAS module, an industrial control system, or a manufacturing facility central controller may monitor, aggregate, preprocess, and output a set of metric values that may be evaluated by the anomaly detection system 100.

Advancing to process block 203, method 200 may create a base dataset that is used, for example, to train a supervised machine learning model, such as a linear regression deep neural network (DNN) ML model, to detect anomalies in the timeseries dataset. To help ensure that the anomaly detection system 100 of FIG. 1 finds anomalies optimally, for example, multiple data windows (“frames”) are created during the training period. Each window—depending on its length—may be processed and evaluated to find anomalies, which may then be compared to actual anomalies that were recorded in a training timeseries dataset, e.g., to select a “correct” window.

An example real-time timeseries dataset may have a select time period of one (1) day; if a metric value is recorded for each second within that select time period, the timeseries dataset will contain 86,400 metric values that are arranged sequentially. In the foregoing example, multiple data windows may be created for the dataset, such as a 5-minute sample window, a 15-minute sample window, a 30-minute sample window, a 1-hour sample window, a 5-hour sample window, etc. A group of base datasets is then created; each base dataset may be generated by subtracting a respective one of the distinct data windows from the timeseries dataset. For the 5-minute sample window, the base dataset will be 23 hours and 55 minutes; for the 1-hour sample window, the base dataset will be 23 hours, and so on until a base dataset is created for each sample window.

The sizes of the foregoing data windows may be determined from the length of the timeseries dataset used for training. To select the window sizes, for example, the following processes may be run: (1) receive timeseries dataset from user; (2) determine size of dataset (i.e., total number of metric values (points)), frequency of dataset (average time between two data points), and overall time of dataset (end time to start time, e.g., in seconds); (3) determine predefined bucket sizes (e.g., 1, 2, 6, 12, 24, 48, 96, 192); and (4) calculate windows using the following formula:

$$Window Size = ( Frequency of Data ) * ( Overall time in seconds ) / ( bucket )$$

The below spreadsheet shows example window sizes created for different bucket sizes:

| | | | |
|---|---|---|---|
| | Frequency (1 | Predefined | Window |
| Seconds (1 day) | value per second) | Bucket | Size |

Example 1

| | | | |
|---|---|---|---|
| 86400 | 1 | 1 | 86400 |
| 86400 | 1 | 2 | 43200 |
| 86400 | 1 | 6 | 14400 |
| 86400 | 1 | 12 | 7200 |
| 86400 | 1 | 24 | 3600 |
| 86400 | 1 | 48 | 1800 |
| 86400 | 1 | 96 | 900 |
| 86400 | 1 | 192 | 450 |

| | | | |
|---|---|---|---|
| Seconds (Half | Frequency | Predefined | Window |
| Day) | (500 ms) | Bucket | Size |

Example 2

| | | | |
|---|---|---|---|
| 43200 | 2 | 1 | 86400 |
| 43200 | 2 | 2 | 43200 |
| 43200 | 2 | 6 | 14400 |
| 43200 | 2 | 12 | 7200 |
| 43200 | 2 | 24 | 3600 |
| 43200 | 2 | 48 | 1800 |
| 43200 | 2 | 96 | 900 |
| 43200 | 2 | 192 | 450 |

| | | | |
|---|---|---|---|
| Seconds (1 | Frequency | Predefined | Window |
| hour) | (100 ms) | Bucket | Size |

Example 3

| | | | |
|---|---|---|---|
| 3600 | 10 | 1 | 36000 |
| 3600 | 10 | 2 | 18000 |
| 3600 | 10 | 6 | 6000 |
| 3600 | 10 | 12 | 3000 |
| 3600 | 10 | 24 | 1500 |
| 3600 | 10 | 48 | 750 |
| 3600 | 10 | 96 | 375 |
| 3600 | 10 | 192 | 187.5 |

After selecting the data windows and creating the base datasets, method 200 may execute two parallel series of processes, which may being by executing process block 205 to generate a forecasted data series and process block 209 to start Euclidean distance modelling. The forecasted data series may be generated by applying one or more statistical timeseries forecasting models to the base datasets. For instance, the base timeseries datasets may be fed into and processed by an Autoregressive Integrated Moving Average (ARIMA) model, an adaptive-aggressive piecewise linear or logistic growth curve model (Prophet), and/or a Long Short-Term Memory (LSTM) based recurrent neural network (RNN) model to forecast a predicted dataset for the timeseries. The system may preload a standard proven Python Package Index (PPI) software repository with the desired statistical forecasting models that will process the timeseries data stream. Method 200 of FIG. 2 may thereafter execute process block 207 to derive a forecasting model that may be used to predict trends and forecast future data points for new timeseries data streams. A forecasting model may be generated by comparing the forecasted data series output at process block 205 with an actual data series. This comparison may be performed through any one or more of the above given models; each model library may provide a way to test the forecasted value against corresponding real value.

Advancing from process block 207 to process block 209, method 200 may perform a moving, pairwise Euclidean distance analysis for the base datasets output at process block 203. Using the selected window size for a given base dataset, method 200 finds a Euclidean distance between two window pairs in the base data and the forecasted dataset. By way of example, and not limitation, a user-created “synthetic” timeseries—rather than a randomly generated timeseries—may be provided that follows a predetermined pattern within its data. The following synthetic timeseries dataset T may represent daily measurement across a twenty (20) day time period:

$$T = [ 3 , 4 , 5 , 4 , 3 , - 1 , 4 , 5 , 4 , 3 , - 1 , 4 , 5 , 4 , 3 , 2 , 2 , 2 , 1 , 0 ]$$

In the foregoing example, the timeseries dataset T has timeseries length Lₙ=20. A window length L_{W} is then selected for the dataset T; a user may wish to analyze the timeseries data for 4-day patterns, i.e., L_{W}=4.

Using the dataset's length and window size, method 200 may then enumerate all data windows of length L_{W} within the subject timeseries dataset T. Enumerating a series of data windows may include calculating a total number of windows W_{T} within the timeseries dataset T as:

$${W}_{T} = {L}_{n} - {L}_{W} + 1$$

where Lₙ is the total number of data values in the sequence of data values in the timeseries dataset T, and L_{W} is the window length determined for the timeseries dataset T. In the above example, Lₙ=20 and L_{W}=4, so W_{T}=17 windows each contained four sequential values. The seventeen windows may be indexed from the first metric value in the dataset (for convenience) and listed as follows:

$$1. ( {T}_{1 : 4} = [ 3 , 4 , 5 , 4 ] )$$

$$2. ( {T}_{2 : 5} = [ 4 , 5 , 4 , 3 ] )$$

$$3. ( {T}_{3 : 6} = [ 5 , 4 , 3 , - 1 ] )$$

$$4. ( {T}_{4 : 7} = [ 4 , 3 , - 1 , 4 ] )$$

$$5. ( {T}_{5 : 8} = [ 3 , - 1 , 4 , 5 ] )$$

$$6. ( {T}_{6 : 9} = [ - 1 , 4 , 5 , 4 ] )$$

$$7. ( {T}_{7 : 10} = [ 4 , 5 , 4 , 3 ] )$$

$$8. ( {T}_{8 : 11} = [ 5 , 4 , 3 , - 1 ] )$$

$$9. ( {T}_{9 : 12} = [ 4 , 3 , - 1 , 4 ] )$$

$$10. ( {T}_{10 : 13} = [ 3 , - 1 , 4 , 5 ] )$$

$$11. ( {T}_{11 : 14} = [ - 1 , 4 , 5 , 4 ] )$$

$$12. ( {T}_{12 : 15} = [ 4 , 5 , 4 , 3 ] )$$

$$13. ( {T}_{13 : 16} = [ 5 , 4 , 3 , 2 ] )$$

$$14. ( {T}_{14 : 17} = [ 4 , 3 , 2 , 2 ] )$$

$$15. ( {T}_{15 : 18} = [ 3 , 2 , 2 , 2 ] )$$

$$16. ( {T}_{16 : 19} = [ 2 , 2 , 2 , 1 ] )$$

$$17. ( {T}_{17 : 20} = [ 2 , 2 , 1 , 0 ] )$$

Next, a conceptual pairwise Euclidean distance calculation may be performed for the enumerated series of data windows of the synthetic timeseries dataset T. It should be noted that the synthetic dataset and corresponding conceptual distance calculation are provided for purposes of explanation; since the timeseries is synthetic, the resultant distance matrix is conceptual. In a real-life application, however, neither a synthetic time series nor a conceptual distance matrix will likely be used. For the distance calculation, method 200 may generate a distance value matrix, which may include determining a matrix size [R_{N}, C_{N}] of the matrix, where R_{N} is a number of rows, C_{N} is a number of columns. When comparing two timeseries datasets of equal size, R_{N}=C_{N}=W_{T}. Continuing with the above example, the system may create a conceptual distance matrix D of size 17×17, a square array with seventeen cells in each row and each column. Each cell D_{i,j} holds a Euclidean distance value between window i and window j. The Euclidean distance D_{E} for two windows A=[a₁, a₂, . . . , aₘ] and B=[b₁, b₂, . . . , bₘ] may be calculated as:

$${D}_{E} = \sqrt{{( {a}_{1} - {b}_{1} )}^{2} + {( {a}_{2} - {b}_{2} )}^{2} + … + {( {a}_{m} - {b}_{m} )}^{2} )}$$

where a₁, a₂, . . . , aₘ are the 1^{st}, 2^{nd}, . . . and m^{th} data values in the respective subsequence of values assigned to the first data window A, and b₁, b₂, . . . , bₘ are the 1^{st}, 2^{nd}, . . . and m^{th} data values in the respective subsequence of values assigned to the second data window B. An example distance calculation may be conducted for the first two windows in the enumerated series of data windows:
T_{1:4}=[3,4,5,4] and T_{2:5}=[4,5,4,3].
Element-wise differences: (3−4, 4−5, 5−4, 4−3)=(−1,−1, 1, 1)
Squares of these differences: [1,1,1,1]
Sum of squares: 1+1+1+1=4
Euclidean distance: sqrt {4}=2
   This type of calculation is performed for every pair of windows in the matrix, i.e. approximately 136 times. If a Euclidean distance matrix was generated for comparing two series of data windows for two timeseries datasets (e.g., comparing a base dataset to a training dataset), this calculation is performed 17×17 times.

After completing the Euclidean distance calculations, method 200 may identify the “nearest neighbor distance” for each window in the series of data windows. In particular, the system may use the distance value matrix to generate a shortest distance (SD) matrix that contains an array of SD values, each of which defines a minimum or shortest distance between each data window and every other data window in the series of data windows. Specifically, each SD value SD[i] may be calculated as:

$$S D [ i ] = min ( {D}_{i , j} )$$

where D_{i,j} is an i^{th} cell in the distance value matrix, and i!=j. Using the enumerated series of data windows of the synthetic timeseries dataset T as an example, the system may begin with evaluating the first window T_{1:4}=[3,4,5,4] (i=1) and computes the distances from T_{1:4} to every other window in the series (i.e., T_{2:5}, T_{3:6}, . . . , T_{17:20}). From these calculations, SD[1] is equal to the smallest of those distance values. This subroutine is repeated for each window index in the series (i.e., i=2, i=3, i=4, . . . i=17).

After identifying the shortest distance value for each window, method 200 may build a shortest distance matrix, which contains an array of the SD values, and examine the SD matrix for trends and irregularities, including any notable data anomalies. In the foregoing example, the shortest distance matrix may be a linear array of seventeen (17) SD values. For instance, the SD matrix may look like:

$$SD = [ 2. , 1.41 , \underline{4.5} , 3.2 , 1.41 , … , \underline{5.2} , … ? ]$$

Once constructed, method 200 searches for “large values” in the array, specifically attempting to identify one or more SD values, if any, that are markedly larger than all other SD values. In the above SD matrix, for example, the third SD value associated with the third data window and the n^{th} SD value associated with the n^{th} data window (both underlined) are noticeably different from every other SD value. Both of these irregularities may be indicative of an anomaly.

Recognizing that not all large values may be anomalies, method 200 may apply a 95^{th} or a 99^{th} percentile rule analysis to the SD matrix data or, for large datasets, may apply an outlier detection protocol. The essence of the 95% Rule in statistics is that, in a bell-shaped (normal) distribution, about 95% of all values lie within two standard deviations (1.96 standard deviations) from the mean. Method 200 may therefore arrange the SD values from smallest to largest, and identify any SD values are larger than 95% or 99% of all other SD values as a basis for ascertaining whether or not those large values are indicative of anomalies. As noted above, a timeseries length Lₙ was identified, a window length L_{W} was determined, and a total number of windows was counted. All data windows were then enumerated and concomitantly assigned their respective sequence of metric values. Euclidian distances are then calculated for each window to every other window to build a distance value matrix. A nearest neighbor distance analysis is then conducted to construct the SD matrix; the SD values in the SD matrix are analyzed for any abnormalities. Finding anomalous values may be done simply by sorting the SD value array from descending to ascending or by finding a percentile. To apply the 95^{th} or 99^{th} percentile rule, the lowest 95% or 99% of the SD values are removed and the remaining largest 1^{st} or 5^{th} percentile values may be labelled as anomalies.

With reference again to FIG. 2, method 200 may execute process block 211 and reiterate the moving, pairwise Euclidean distance analysis of process block 209 for every data window and, thus, every base dataset output at process block 203. In particular, a pairwise Euclidean distance analysis and nearest neighbor distance analysis may be run between each base dataset in the timeseries dataset and the forecasted data series output at process block 205 to identify the shortest distances in each iteration. At block 213, method 200 may apply the 95^{th} percentile rule analysis on the shortest distance data to identify the anomalies. In tandem, method 200 may advance to process block 215 and concurrently apply an outlier detection protocol on the shortest distance data and compare these results against the results of the 95^{th} percentile analysis generated at process block 213. One non-limiting example of an industry-proven algorithm engine for outlier detection is the Python Outlier Detection (PyOD) library. Rather than using PyOD directly on a subject timeseries dataset, which may produce false positives unless manually “cleaned” by data scientists for outlier detection viability, PyOD may be applied to the SD matrices with data that has been “flattened”.

Process block 217 of FIG. 2 then reruns steps 209 to 215 of method 200 for different window sizes. The parallel threads compares forecasting models from 207 at process block 208 and generates a future forecasted data at process block 210. Steps 210 and 215 mark the completion of the 2 parallel threads and process block 218 generates anomalies from 215 model on 203 and 210 based data. At process block 219, method 200 compares the anomalies obtained from steps for different window sizes with actual anomalies in the base dataset. Upon completion of some or all of the control operations presented in FIG. 2, method 200 may advance to END terminal block 221 and temporarily terminate or, optionally, may loop back to terminal block 201 and run in a continuous loop (e.g., until no vehicle occupants are detected or a predefined time period has lapsed).

Applications in which the anomaly detection system is trained using historical data, the above processes may be run on a real-time timeseries dataset with the following process:
1. using streaming data, forecast future points with a predefined window and forecast model obtained during training (the forecast of the data may be done for a period of the window size);
2. as new data arrives, append the new data to prior dataset (the forecast may be validated in parallel to appending real data to existing dataset);
3. in the background, as new data is appended to the existing timeseries dataset, automatically compare a new window with all of existing windows and update the historical values;
4. determine which one of the existing windows is a shortest distance and append this information to the shortest distance data; and
5. once new data equivalent to the original length of the existing timeseries dataset is obtained, the entire data is trained again (as more data flows in, both forecasting and anomaly detection work seamlessly).

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of analyzing datasets to detect anomalies in data values contained in the datasets, the method comprising:
receiving, via a system controller from a data source, a timeseries dataset containing a sequence of data values recorded within a select time period;
determining, via the system controller for the timeseries dataset, a window length defining a number of sequential values in the sequence of data values assigned to each of a series of data windows;
enumerating, via the system controller from the timeseries dataset, the series of data windows including assigning a respective subsequence of values from the sequence of data values to each data window in the series of data windows;
generating, via the system controller based on a total number of the data windows, a distance value matrix containing an array of matrix cells, each cell in the array of matrix cells including a Euclidean distance between a respective pair of the data windows;
generating, via the system controller from the distance value matrix, a shortest distance (SD) matrix containing an array of SD values, each of the SD values defining a shortest distance between each of the data windows and every other one of the data windows; and
analyzing, via the system controller, the SD array to determine whether or not one of the SD values is irregular relative to the other SD values and thereby indicates an anomaly.

2. The method of claim 1, wherein enumerating the series of data windows includes calculating a total number of windows as W_{T}, where:
$${W}_{T} = {L}_{n} - {L}_{W} + 1$$
where Lₙ is a total number of data values in the sequence of data values in the timeseries dataset T, and L_{W} is the window length determined for the timeseries dataset T.

3. The method of claim 2, wherein generating the distance value matrix includes determining a matrix size [R_{N}, C_{N}] of the distance value matrix, where R_{N} is a number of rows, C_{N} is a number of columns, and R_{N}=C_{N}=W_{T}.

4. The method of claim 1, wherein generating the distance value matrix includes calculating each of the Euclidean distances as D_{E}(A, B), where:
$${D}_{E} = √ [ {( {a}_{1} - {b}_{1} )}^{2} + {( {a}_{2} - {b}_{2} )}^{2} + … + {( {a}_{m} - {b}_{m} )}^{2} ]$$
where A=[a₁, a₂, . . . , aₘ] is a first data window in the respective pair of the data windows, a₁, a₂, . . . , aₘ are the 1^{st}, 2^{nd}, . . . and m^{th} data values in the respective subsequence of values assigned to the first data window A, B=[b₁, b₂, . . . , bₘ] is a second data window in the respective pair of the data windows, and b₁, b₂, . . . , bₘ are the 1^{st}, 2^{nd}, . . . and m^{th} data values in the respective subsequence of values assigned to the second data window B.

5. The method of claim 1, wherein generating the SD matrix includes calculating each of the SD values as SD[i], where:
$$S D [ i ] = min ( {D}_{i , j} )$$
where D_{i,j} is an i^{th} cell in the distance value matrix, and where i!=j.

6. The method of claim 1, wherein analyzing the SD array includes determining whether or not each of the SD values in the SD array is significantly larger than all other of the SD values in the SD matrix.

7. The method of claim 6, wherein determining whether or not each of the SD values is significantly larger than all other of the SD values in the SD matrix includes applying a 95^{th} or 99^{th} percentile rule analysis to each of the SD values in the SD matrix.

8. The method of claim 1, further comprising training a supervised machine learning (SML) model to detect anomalies in the timeseries dataset, the training including receiving a training timeseries dataset containing one or more recorded anomalies, and determining multiple distinct data windows for the timeseries dataset.

9. The method of claim 8, wherein training the SML model further includes creating multiple base datasets, each of the base datasets being created by subtracting a respective one of the distinct data windows from the timeseries dataset.

10. The method of claim 9, wherein training the SML model further includes:
generating a forecasted data series by applying one or more statistical timeseries forecasting models to the base datasets; and
deriving a forecasting model by comparing the forecasted data series with the timeseries dataset.

11. The method of claim 10, wherein training the SML model further includes finding the Euclidean distance between respective pairs of data windows in the base datasets and the forecasted data series.

12. The method of claim 11, wherein training the SML model further includes:
generating a training SD matrix containing an array of training SD values, each of the SD values defining a shortest distance between each of the respective pairs of the data windows in the base datasets and the forecasted data series; and
determining if one or more anomalies are present by applying a 95^{th} or 99^{th} percentile rule analysis to determine if each of the training SD values is significantly larger than all other of the training SD values in the training SD matrix.

13. The method of claim 1, wherein the data source includes a WiFi-enabled sensor and the timeseries dataset includes a real-time sensor data stream output by the WiFi-enabled sensor, the method further comprising modulating a sensor operating threshold of the WiFi-enabled sensor based on the analyzing of the SD array.

14. A non-transient, computer-readable medium (CRM) storing instructions executable by a system controller, the instructions, when executed, causing the system controller to perform operations comprising:
receiving, from a data source, a timeseries dataset containing a sequence of data values recorded within a select time period;
determining, for the timeseries dataset, a window length defining a number of sequential values in the sequence of data values assigned to each of a series of data windows;
enumerating, from the timeseries dataset, the series of data windows including assigning a respective subsequence of values from the sequence of data values to each data window in the series of data windows;
generating, based on a total number of the data windows, a distance value matrix containing an array of matrix cells, each cell in the array of matrix cells including a Euclidean distance between a respective pair of the data windows;
generating, from the distance value matrix, a shortest distance (SD) matrix containing an array of SD values, each of the SD values defining a shortest distance between each of the data windows and every other one of the data windows; and
analyzing the SD array to determine whether or not one of the SD values is irregular relative to the other SD values and thereby indicates an anomaly.

15. The non-transient CRM of claim 14, wherein enumerating the series of data windows includes calculating a total number of windows as W_{T}, where:
$${W}_{T} = {L}_{n} - {L}_{W} + 1$$
where Lₙ is a total number of data values in the sequence of data values in the timeseries dataset T, and L_{W} is the window length determined for the timeseries dataset T.

16. The non-transient CRM of claim 15, wherein generating the distance value matrix includes determining a matrix size [R_{N}, C_{N}] of the distance value matrix, where R_{N} is a number of rows, C_{N} is a number of columns, and R_{N}=C_{N}=W_{T}.

17. The non-transient CRM of claim 14, wherein generating the distance value matrix includes calculating each of the Euclidean distances as D_{E}(A, B), where:
$${D}_{E} = √ [ {( {a}_{1} - {b}_{1} )}^{2} + {( {a}_{2} - {b}_{2} )}^{2} + … + {( {a}_{m} - {b}_{m} )}^{2} ]$$
where A=[a₁, a₂, . . . , aₘ] is a first data window in the respective pair of the data windows, a₁, a₂, . . . , aₘ are the 1^{st}, 2^{nd}, . . . and m^{th} data values in the respective subsequence of values assigned to the first data window A, B=[b₁, b₂, . . . , bₘ] is a second data window in the respective pair of the data windows, and b₁, b₂, . . . , bₘ are the 1^{st}, 2^{nd}, . . . and m^{th} data values in the respective subsequence of values assigned to the second data window B.

18. The non-transient CRM of claim 14, wherein generating the SD matrix includes calculating each of the SD values as SD[i], where:
$$S D [ i ] = min ( {D}_{i , j} )$$
where D_{i,j} is an i^{th} cell in the distance value matrix, and where i!=j.

19. The non-transient CRM of claim 14, wherein analyzing the SD array includes determining whether or not each of the SD values in the SD array is significantly larger than all other of the SD values in the SD matrix.

20. The non-transient CRM of claim 19, wherein determining whether or not each of the SD values is significantly larger than all other of the SD values in the SD matrix includes applying a 95^{th} or 99^{th} percentile rule analysis to each of the SD values in the SD matrix.
